(19) United States
(12) Patent Application Publication
(10) Pub. No.: US 2017/0092025 A1
(43) Pub. Date: Mar. 30, 2017

(54) Key Fob Cover System

(71) Applicant: Patrick Little, Fosters, AL (US)

(72) Inventor: Patrick Little, Fosters, AL (US)

(21) Appl. No.: 14/865,595

(22) Filed: Sep. 25, 2015

(51) Int. Cl. G07C 9/00

(52) U.S. Cl. CPC G07C 9/00007

(57) ABSTRACT

A key fob cover system for inhibiting a key fob from being inadvertently manipulated includes a key fob. A plurality of buttons is provided and each of the buttons is coupled to the key fob. Thus, each of the buttons may be manipulated. A cover is slidably positioned on the key fob. The cover covers the buttons when the cover is positioned on the key fob such that the cover inhibits the buttons from being inadvertently manipulated.

### BACKGROUND OF THE DISCLOSURE

### Field of the Disclosure

The disclosure relates to cover devices and more particularly pertains to a new cover device for inhibiting a key fob from being inadvertently manipulated.

### SUMMARY OF THE DISCLOSURE

An embodiment of the disclosure meets the needs presented above by generally comprising a key fob. A plurality of buttons is provided and each of the buttons is coupled to the key fob. Thus, each of the buttons may be manipulated. A cover is slidably positioned on the key fob. The cover covers the buttons when the cover is positioned on the key fob such that the cover inhibits the buttons from being inadvertently manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a key fob cover system according to an embodiment of the disclosure.

FIG. 2 is an exploded perspective view of an embodiment of the disclosure.

FIG. 3 is a bottom view of an embodiment of the disclosure.

FIG. 4 is a front view of an embodiment of the disclosure.

FIG. 5 is a right side view of an embodiment of the disclosure.

### DESCRIPTION OF THE PREFERRED EMBODIMENT

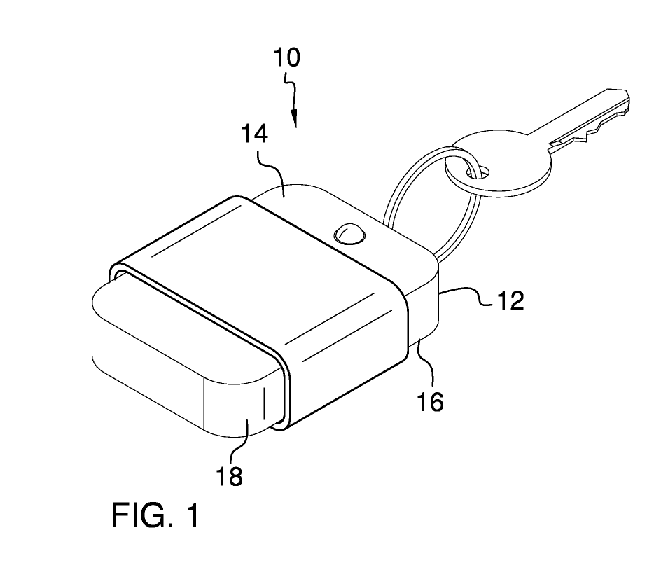

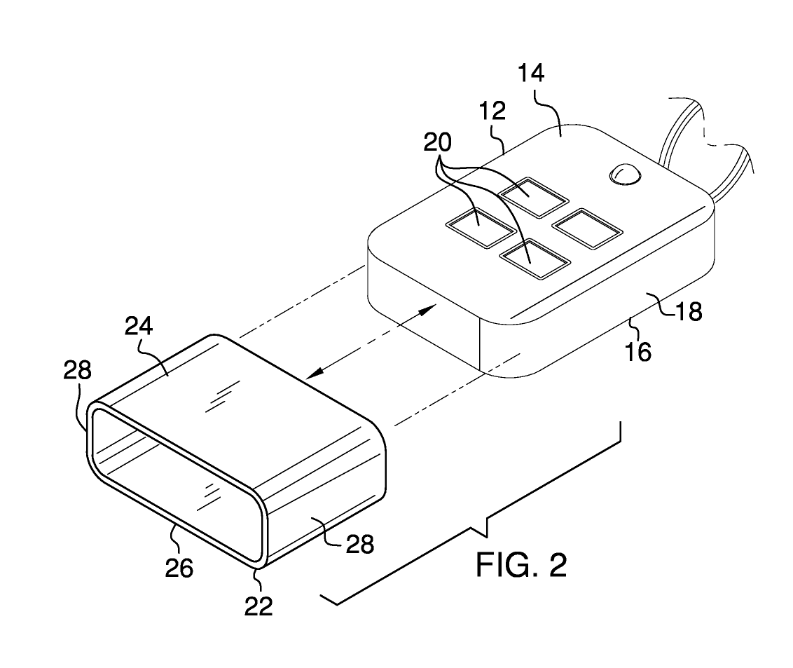

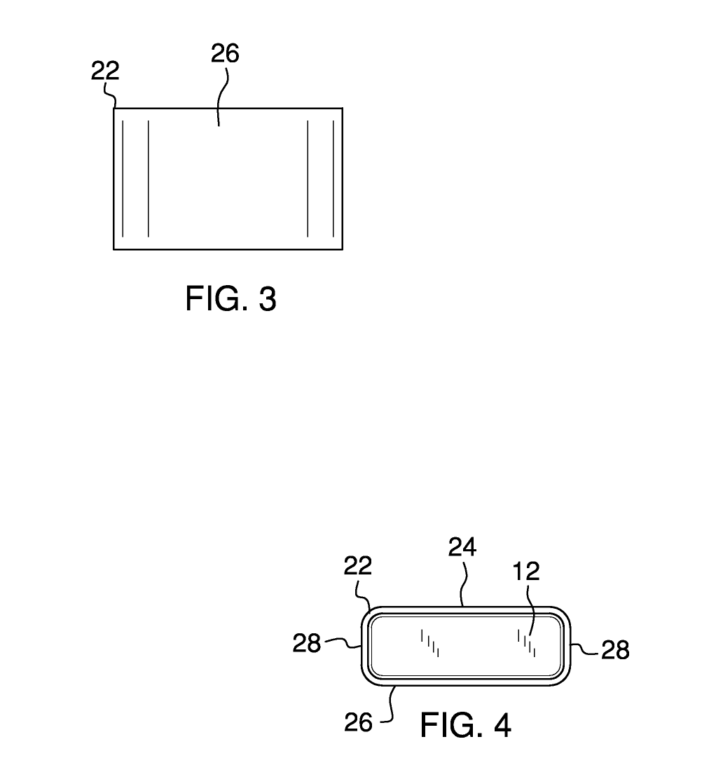

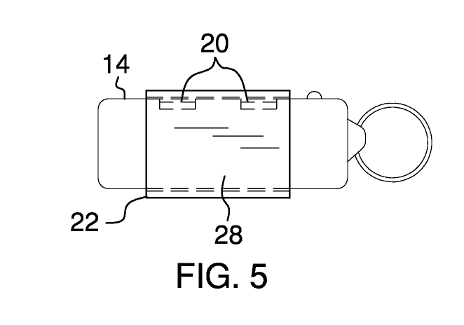

With reference now to the drawings, and in particular to FIGS. 1 through 5 thereof, a new cover device embodying the principles and concepts of an embodiment of the disclosure and generally designated by the reference numeral 10 will be described.

As best illustrated in FIGS. 1 through 5, the key fob cover system 10 generally comprises a key fob 12 that has a top side 14, a bottom side 16 and a peripheral edge 18 extending between the top side 14 and the bottom side 16. The key fob 12 may comprise an electronic key fob or the like. A plurality of buttons 20 is provided and each of the buttons 20 is coupled to the key fob 12. Each of the buttons 20 is positioned on the top side 14 and each of the buttons 20 may be manipulated. Thus, the buttons 20 control operational parameters of the key fob 12. The buttons 20 are spaced apart from each other and distributed on the top side 14.

A cover 22 is provided and the cover 22 is slidably positioned on the key fob 12. The cover 22 covers the buttons 20 when the cover 22 is positioned on the key fob 12. Thus, the cover 22 inhibits the buttons 20 from being inadvertently manipulated. The cover 22 has a first wall 24, a second wall 26 and a pair of lateral walls 28.

Each of the lateral walls 28 extends between the first wall 24 and the second wall 26 such that the first wall 24 is spaced from the second wall 26. The lateral walls 28 are spaced apart from each other such that the cover 22 forms a rectangular tube. The cover 22 insertably receives the key fob 12 such that the first wall 24 covers the buttons 20. The second wall 26 covers the bottom side 16 and the lateral walls 28 cover the peripheral edge 18. The cover 22 is removable from the key fob 12 such that the buttons 20 are exposed.

The cover 22 is comprised of a resiliently deformable material such as rubber or the like. The first wall 24 of the cover 22 may be depressed at a location that is aligned with a selected one of the buttons 20. Thus, the selected button 20 may be manipulated while the cover 22 is positioned over the buttons 20. The first wall 24 resists being depressed such that the buttons 20 are inhibited from being manipulated without sufficient pressure. The pressure required to depress the first wall 24 may be equivalent to a weight ranging between approximately one half kg and one kg. Thus, the cover 22 inhibits the buttons 20 from being inadvertently manipulated when the key fob 12 is stored in a pocket of clothing or the like.

In use, the key fob 12 is inserted into the cover 22 when the key fob 12 is to be stored in the pocket of clothing or the like. The first wall 24 is depressed at the location that is aligned with the selected button 20 when the key fob 12 is positioned within the cover 22. Thus, the key fob 12 is utilized when the key fob 12 is positioned within the cover 22. The key fob 12 may be utilized while the key fob 12 is positioned within the cover 22 or when the key fob 12 is not positioned within the cover 22.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A key fob cover system comprising:
a key fob;
a plurality of buttons, each of said buttons being coupled to said key fob wherein each of said buttons is configured to be manipulated; and
a cover being slidably positioned on said key fob, said cover covering said buttons when said cover is positioned on said key fob such that said cover inhibits said buttons from being inadvertently manipulated;
said cover insertably receiving said key fob such that said first wall covers said buttons, said cover being removable from said key fob such that said buttons are exposed, said cover being comprised of a resiliently deformable material wherein said first wall is configured to be depressed at a location being aligned with a selected one of said buttons thereby facilitating said selected button to be manipulated when said cover is positioned on said key fob.

2. The system according to claim 1, wherein said key fob has a top side, a bottom side and a peripheral edge extending between said top side and said bottom side.

3. The system according to claim 2, wherein each of said buttons is positioned on said top side, said buttons being spaced apart from each other and distributed on said top side.

4. The system according to claim 1, wherein said cover has a first wall, a second wall and a pair of lateral walls, each of said lateral walls extending between said first wall and said second wall such that said first wall is spaced from said second wall, said lateral walls being spaced apart from each other such that said cover forms a rectangular tube.

5. (canceled)

6. (canceled)

7. A key fob cover system comprising:
a key fob having a top side, a bottom side and a peripheral edge extending between said top side and said bottom side;
a plurality of buttons, each of said buttons being coupled to said key fob, each of said buttons being positioned on said top side wherein each of said buttons is configured to be manipulated, said buttons being spaced apart from each other and distributed on said top side; and
a cover being slidably positioned on said key fob, said cover covering said buttons when said cover is positioned on said key fob such that said cover inhibits said buttons from being inadvertently manipulated, said cover having a first wall, a second wall and a pair of lateral walls, each of said lateral walls extending between said first wall and said second wall such that said first wall is spaced from said second wall, said lateral walls being spaced apart from each other such that said cover forms a rectangular tube, said cover insertably receiving said key fob such that said first wall covers said buttons, said cover being removable from said key fob such that said buttons are exposed, said cover being comprised of a resiliently deformable material wherein said first wall is configured to be depressed at a location being aligned with a selected one of said buttons thereby facilitating said selected button to be manipulated when said cover is positioned on said key fob.
